(19) United States
(12) Patent Application Publication
(10) Pub. No.: US 2026/0276862 A1
(43) Pub. Date: Sep. 17, 2026

(54) SYSTEM FOR PREDICTING WEATHER CHANGES

(71) Applicant: SoftBank Group Corp., Tokyo (JP)

(72) Inventor: Norihiro SAKAE, Tokyo (JP)

(21) Appl. No.: 19/561,552

(22) Filed: Mar. 10, 2026

Related U.S. Application Data
(60) Provisional application No. 63/770,992, filed on Mar. 13, 2025.

(51) Int. Cl. G01W 1/10; G05B 13/02; G05B 13/04

(52) U.S. Cl. CPC G01W 1/10; G05B 13/0265; G05B 13/048

(57) ABSTRACT

An automatic protection system for protecting agricultural crops by collecting weather data in real time, predicting guerrilla heavy rains and local climate changes with high accuracy using artificial intelligence. A data collection unit acquires data from weather satellites and ground-based observation stations, and a prediction analysis unit performs analysis using a machine learning algorithm. Based on the prediction results, a protection execution unit activates a robot that automatically stacks sandbags to form a protective wall to protect crops. Furthermore, a monitoring unit monitors the situation at the site and adjusts the protective measures as necessary. A feedback unit evaluates the effect of the executed measures and collects data for improving the accuracy of the prediction model.

### CROSS-REFERENCE TO RELATED APPLICATIONS

This application is based upon and claims the benefit of priority from U.S. Provisional Patent Application No. 63/770,992, filed on Mar. 13, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to minimize damage to agricultural crops due to sudden weather changes. In particular, guerrilla heavy rains (torrential rains) and local climate changes are difficult to predict, and it is difficult to respond quickly and appropriately with related art methods. For this reason, agricultural workers are often forced to take reactive measures, which often results in crop loss and quality degradation. Disclosed herein is a system that automatically executes appropriate protective measures in advance by collecting weather data in real time and predicting weather changes with high accuracy using AI. This enables agricultural workers to respond quickly and efficiently to weather disasters, and can significantly reduce crop damage. In addition, the automation of the system also contributes to reducing labor shortages and work burdens, and aims to support sustainable agricultural management.

Disclosed herein is a system including a data collection unit that collects weather data, a prediction analysis unit that analyzes the collected weather data to predict weather changes, and a protection execution unit that automatically executes protective measures based on the predicted weather changes. The data collection unit acquires weather data in real time from weather satellites, ground-based weather observation stations, weather radars, and the like, and the prediction analysis unit analyzes these data using a machine learning algorithm to predict the occurrence of guerrilla heavy rains and local climate changes with high accuracy. The protection execution unit, based on the prediction result, activates a robot that automatically stacks sandbags and takes protective measures to protect crops. This enables agricultural workers to respond quickly and efficiently to weather disasters, and can minimize crop damage.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of predicting weather changes.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

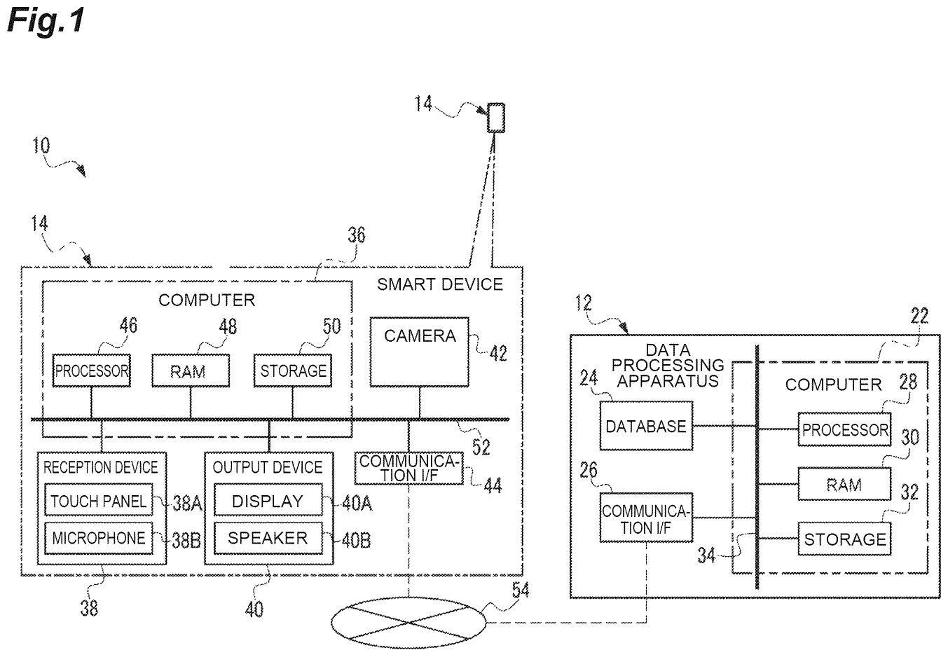

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

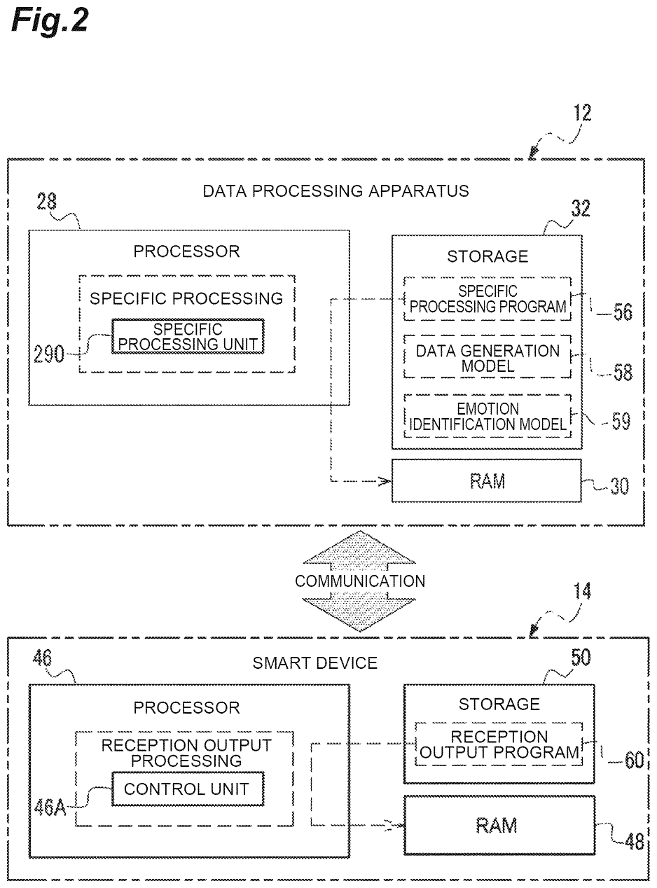

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

This system is realized using a server and a terminal, and each unit fulfills its respective role to protect agricultural crops from weather disasters.

First, a data collection unit is implemented on the server. The server collects weather data in real time from a plurality of data sources. For example, it acquires the movement of clouds and precipitation patterns over the entire globe from weather satellites. This makes it possible to grasp weather changes over a wide area. Furthermore, it acquires detailed data such as local temperature, humidity, wind speed, wind direction, and atmospheric pressure from ground-based weather observation stations. This data is important for grasping detailed weather conditions in a specific area. In addition, a weather radar can capture the intensity and movement of precipitation in real time, and is particularly useful for detecting sudden weather changes such as guerrilla heavy rains. This data is integrated on the server and used as basic data for analysis.

The data collection unit may employ an edge computing architecture in order to reduce the load on communication bandwidth and ensure real-time performance. At each weather observation station or sensor node (IoT device), primary processing (noise removal, normalization, filtering of outliers) is performed on collected raw data, and a Message Queuing Telemetry Transport (MQTT) protocol is used to transmit only change points and important data to the server. This minimizes communication delay (latency) when a sudden change such as guerrilla heavy rain occurs, avoiding a situation where a robot activation command is not received in time.

The data collection unit may be configured by, for example, the computer 22 (the processor 28 or the like) of the data processing apparatus 12, or may be configured by the specific processing unit 290, the specific processing program 56, the data generation model 58, or the like.

Next, a prediction analysis unit is also implemented on the server. The server analyzes the collected weather data using a machine learning algorithm and predicts the occurrence of guerrilla heavy rains and local climate changes. For example, by using algorithms such as deep learning and a recurrent neural network (RNN), it analyzes time-series data and realizes high-accuracy prediction. For example, by learning from past weather data and recognizing specific patterns, the accuracy of prediction can be improved. Furthermore, by combining a plurality of models using ensemble learning, the reliability of the prediction can be enhanced.

The machine learning algorithm in the prediction analysis unit may be configured to include a hybrid model (multimodal deep learning model) combining a Convolutional Neural Network (CNN) that processes spatial data (image data) from a weather radar and a Long Short-Term Memory network (LSTM) that processes time-series sensor data (temperature, atmospheric pressure, etc.). This model has learned correlations between precipitation patterns and terrain data in past disaster cases, and may predict an inundation depth within 30 minutes in a specific agricultural land in units of centimeters with respect to input real-time data. This process is impossible for a human to perform as a mental process, and since processing delay occurs in a general-purpose computer, the process can be executed on the order of several milliseconds using a parallel arithmetic processor such as a GPU or a TPU.

The prediction analysis unit may include an evaluation module that integrates results of a plurality of different prediction models (ensemble learning) by majority vote or weighted average in order to reduce a risk that a predicted weather change is a “false positive.” This produces a technical effect of preventing energy consumption due to unnecessary activation of the robot and preventing hindrance to work.

The prediction analysis unit may be configured by, for example, the computer 22 (the processor 28 or the like) of the data processing apparatus 12, or may be configured by the specific processing unit 290, the specific processing program 56, the data generation model 58, or the like.

A protection execution unit is implemented on the terminal. The terminal automatically executes protective measures at the site based on the prediction results transmitted from the server. For example, a robot that automatically stacks sandbags is connected to the terminal and is activated according to the predicted weather changes. For example, it uses GPS and sensors to place sandbags at accurate positions and forms a protective wall to protect crops. In addition, it can activate a drainage pump as necessary and discharge excess water to prevent flood damage. Furthermore, the robot is provided with a sensor for detecting obstacles and can safely stack sandbags.

Control of the robot by the protection execution unit can be executed according to the following algorithm. First, three-dimensional terrain data of an “area with high inundation risk” identified by the prediction analysis unit is acquired. Next, based on a fluid dynamics simulation, an optimal placement line (protection line) of sandbags for blocking inflow of water is calculated. Subsequently, the shortest and safe movement route from a current position of the robot to a sandbag storage location and then to the placement line is calculated using an A* (A-star) algorithm or Dijkstra's algorithm. Finally, a command signal is transmitted to an arm control module of the robot to calculate a center of gravity position and a gripping point of a sandbag, and to stack sandbags in a specific pattern such as a “running bond pattern” (staggered stacking) to prevent collapse during stacking.

This series of processes directly converts prediction data (input) of weather changes into operation commands (output) for a physical robot, and does not stop at mere presentation of information but changes a physical state (protection state of crops) in the real world.

The protection execution unit may be configured by, for example, the computer 36 (the processor 46 or the like) of the smart device 14, or may be configured by the control unit 46A, the reception output program 60, or the like.

The terminal continuously monitors the situation at the site and transmits feedback to the server. This allows the server to collect data for improving the accuracy of the prediction model and to utilize it for subsequent predictions. For example, it evaluates the effect of the executed protective measures and provides information for improving the model if the prediction was incorrect. Furthermore, the terminal can monitor the work status at the site and adjust the work as necessary.

The feedback unit of the terminal may measure a state of installed sandbags (presence or absence of gaps, height) and an actual water level in real time using the camera 42 or a LiDAR sensor mounted on the robot. When a divergence equal to or greater than a threshold value occurs between a predicted water level rise speed and an actual water level rise speed, the system immediately dynamically updates a parameter (weight coefficient) of the prediction model and commands input of an additional robot or an increase in output of a drainage pump. This closed-loop control realizes a fail-safe function that minimizes physical damage even when a prediction is incorrect.

The feedback unit may be configured by, for example, the computer 36 (the processor 46 or the like) of the smart device 14, the reception device 38 (the touch panel 38A, the microphone 38B, or the like), the camera 42, a sensor (not illustrated), or the like, or may be configured by the control unit 46A, the reception output program 60, or the like.

In this way, the system, by linking the server and the terminal, enables real-time weather data collection, analysis, prediction, and automatic execution of protective measures at the site, and supports agricultural workers in responding quickly and efficiently to weather disasters. This makes it possible to minimize crop damage and realize sustainable agricultural management.

### (System Configuration)

The system includes a data collection unit, a prediction analysis unit, a protection execution unit, a monitoring unit, and a feedback unit. The data collection unit has a function of acquiring weather data in real time from weather satellites, ground-based weather observation stations, weather radars, and the like. For example, it acquires wide-area cloud movement and precipitation patterns from weather satellites, and acquires detailed data such as local temperature, humidity, wind speed, wind direction, and atmospheric pressure from ground-based weather observation stations. In addition, a weather radar can capture the intensity and movement of precipitation in real time, and is particularly useful for detecting sudden weather changes such as guerrilla heavy rains. This data is integrated on the server and used as basic data for analysis.

The prediction analysis unit has a function of analyzing the collected weather data using a machine learning algorithm and predicting the occurrence of guerrilla heavy rains or local climate changes. For example, by using algorithms such as deep learning and a recurrent neural network, it analyzes time-series data and realizes high-accuracy prediction. For example, by learning from past weather data and recognizing specific patterns, the accuracy of prediction can be improved. Furthermore, by combining a plurality of models using ensemble learning, the reliability of the prediction can be enhanced. A specific example of a prompt sentence to be read into a generative AI is “Predict guerrilla heavy rains that may occur within the next 24 hours based on weather data from the past 10 years.”

The protection execution unit has a function of automatically executing protective measures at the site based on the predicted weather changes. For example, a robot that automatically stacks sandbags is connected to the terminal and is activated according to the predicted weather changes. For example, it uses GPS and sensors to place sandbags at accurate positions and forms a protective wall to protect crops. In addition, it can activate a drainage pump as necessary and discharge excess water to prevent flood damage. Furthermore, the robot is provided with a sensor for detecting obstacles and can safely stack sandbags.

The monitoring unit has a function of continuously monitoring the situation at the site and adjusting the protective measures as necessary. For example, if the prediction is incorrect or if there is more precipitation than predicted, it takes measures such as stacking additional sandbags. In addition, it can monitor the work status at the site and adjust the work as necessary.

The feedback unit has a function of evaluating the effect of the executed protective measures and collecting data for improving the accuracy of the prediction model. For example, it evaluates the effect of the executed protective measures and provides information for improving the model if the prediction was incorrect. This makes it possible to improve the accuracy of subsequent predictions.

In this way, the system supports agricultural workers in responding quickly and efficiently to weather disasters by having each unit cooperate to perform weather data collection, analysis, prediction, execution of protective measures at the site, and feedback. This makes it possible to minimize crop damage and realize sustainable agricultural management.

### (Implementation Steps)

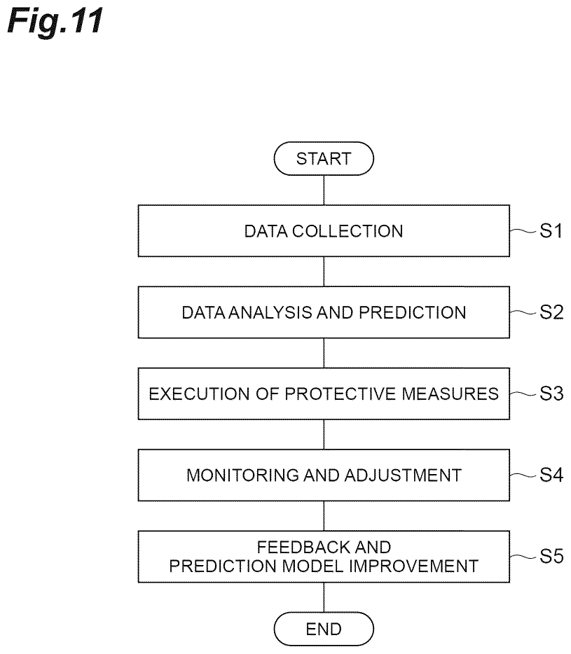

Step 1: Data Collection (refer to step S1 of FIG. 11) In this step, weather data is collected in real time from weather satellites, ground-based weather observation stations, weather radars, and the like. Wide-area cloud movement and precipitation patterns are acquired from weather satellites, and detailed data such as local temperature, humidity, wind speed, wind direction, and atmospheric pressure are acquired from ground-based weather observation stations. A weather radar can capture the intensity and movement of precipitation in real time, and is particularly useful for detecting sudden weather changes such as guerrilla heavy rains. This data is integrated on the server and used as basic data for analysis.

Step 2: Data Analysis and Prediction (refer to step S2 of FIG. 11) Using the collected weather data, analysis is performed by a machine learning algorithm to predict the occurrence of guerrilla heavy rains and local climate changes. For example, by using deep learning and a recurrent neural network, time-series data is analyzed to realize high-accuracy prediction. A specific example of a prompt sentence to be read into a generative AI is “Predict guerrilla heavy rains that may occur within the next 24 hours based on weather data from the past 10 years.”

Step 3: Execution of Protective Measures (refer to step S3 of FIG. 11)

Based on the predicted weather changes, protective measures are automatically executed at the site. For example, a robot that automatically stacks sandbags is connected to the terminal and is activated according to the predicted weather changes. It uses GPS and sensors to place sandbags at accurate positions and forms a protective wall to protect crops. In addition, it can activate a drainage pump as necessary and discharge excess water to prevent flood damage.

Step 4: Monitoring and Adjustment (refer to step S4 of FIG. 11) The situation at the site is continuously monitored, and the protective measures are adjusted as necessary. For example, if the prediction is incorrect or if there is more precipitation than predicted, measures such as stacking additional sandbags are taken. In addition, the work status at the site can be monitored and the work can be adjusted as necessary.

Step 5: Feedback and Model Improvement (refer to step S5 of FIG. 11)

The effect of the executed protective measures is evaluated, and data is collected to improve the accuracy of the prediction model. For example, the effect of the executed protective measures is evaluated, and if the prediction was incorrect, information is provided to improve the model. This makes it possible to improve the accuracy of subsequent predictions.

### (Specific Use Case)

For example, consider a case where the system is implemented in a certain agricultural region to minimize crop damage from guerrilla heavy rains. In this region, weather changes are drastic, and especially in summer, local heavy rains occur frequently, so a prompt response is required.

First, the data collection unit collects data in real time from weather satellites, ground-based weather observation stations, and weather radars. Wide-area cloud movement and precipitation patterns are acquired from weather satellites, and detailed data such as local temperature, humidity, wind speed, wind direction, and atmospheric pressure are acquired from ground-based weather observation stations. A weather radar can capture the intensity and movement of precipitation in real time, and is particularly useful for detecting sudden weather changes such as guerrilla heavy rains.

Next, the prediction analysis unit uses this data to perform analysis using a machine learning algorithm and predict the occurrence of guerrilla heavy rains. A specific example of a prompt sentence to be read into a generative AI is “Predict guerrilla heavy rains that may occur in this region within the next 24 hours based on weather data from the past 10 years.” This improves the accuracy of the prediction and enables a prompt response.

Based on the prediction result, the protection execution unit automatically executes protective measures at the site. For example, a robot that automatically stacks sandbags is activated, and uses GPS and sensors to place sandbags at accurate positions to form a protective wall to protect crops. In addition, it can activate a drainage pump as necessary and discharge excess water to prevent flood damage.

Furthermore, the monitoring unit continuously monitors the situation at the site and adjusts the protective measures as necessary. For example, if the prediction is incorrect or if there is more precipitation than predicted, it takes measures such as stacking additional sandbags. In addition, it can monitor the work status at the site and adjust the work as necessary.

Finally, the feedback unit evaluates the effect of the executed protective measures and collects data to improve the accuracy of the prediction model. This makes it possible to improve the accuracy of subsequent predictions. For example, it evaluates the effect of the executed protective measures and provides information for improving the model if the prediction was incorrect.

In this way, the system supports agricultural workers in responding quickly and efficiently to weather disasters by performing real-time weather data collection, analysis, prediction, execution of protective measures at the site, and feedback, and can minimize crop damage.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is an automatic protection system for protecting infrastructure and residents from weather disasters, targeting an entire city. The system mainly includes a data collection unit, a prediction analysis unit, a protection execution unit, a monitoring unit, and a feedback unit.

The data collection unit collects data in real time from various sensors and devices installed throughout the city. For example, weather sensors provide data such as temperature, humidity, wind speed, and precipitation, and these are installed on streetlights, traffic lights, and the roofs of public facilities. This makes it possible to capture minute weather changes at various locations in the city. Furthermore, surveillance cameras visually detect road flooding and the scattering of objects by wind. These cameras are installed at major intersections and around public facilities and transmit images in real time. In addition, drones cover a wide area from the air and are useful for grasping the situation in areas that are particularly difficult to access. Drones can fly to the site quickly in the event of a disaster and confirm the damage situation from above. This makes it possible to quickly detect local weather changes and signs of disasters.

The prediction analysis unit transmits the collected data to an AI platform on the cloud and performs analysis. The AI compares past weather data with real-time data and detects abnormal patterns. For example, by using deep learning and a recurrent neural network, it analyzes time-series data and realizes high-accuracy prediction. This makes it possible to predict the possibility of disasters such as floods, strong winds, and thunderstorms in specific areas within the city with high accuracy. The AI can perform more precise predictions by taking into account not only weather data but also topographical data and population density data. For example, areas located in low-lying areas have a higher risk of flooding, so special attention is required.

The protection execution unit automatically executes protective measures to protect the infrastructure and residents in the city based on the prediction results. For example, in areas where a flood is predicted, a system is activated in which drainage pumps installed underground are automatically activated to quickly discharge rainwater. This can prevent the flooding of roads and subways. The drainage pumps cooperate with the city's drainage network to efficiently discharge water. In addition, when strong winds are predicted, robots for strengthening the fixation of roadside trees and signboards are activated to perform physical reinforcement work. These robots can grasp the surrounding situation using sensors and perform appropriate reinforcement work. Furthermore, it is possible to adjust the operation of public transportation and take measures to ensure the safety of passengers. For example, by changing the operation schedules of buses and trains, access to areas requiring evacuation is ensured.

The monitoring unit continuously monitors the situation of the entire city, and if the prediction is incorrect or the situation changes, it quickly adjusts the protective measures. For example, if there is more precipitation than predicted, a backup drainage pump is operated to take additional drainage measures. In addition, by monitoring traffic congestion and the congestion of evacuation routes and adjusting the timing of traffic signals as necessary, it supports smooth evacuation. The monitoring unit collects data in real time and supports quick decision-making.

The feedback unit evaluates the effect of the executed protective measures and collects data for improving the accuracy of the AI model. For example, it analyzes how effective the executed protective measures were, and if the prediction was incorrect, it identifies the cause and provides information for improving the model. This makes it possible to improve the accuracy of subsequent predictions and strengthen the disaster prevention capabilities of the entire city. The feedback unit accumulates data on past disaster responses and can more effectively prepare for future disasters.

In this way, the system enables a quick and efficient response to weather disasters in the entire city, and can realize the safety of residents and the protection of infrastructure.

### (System Configuration)

The system includes a data collection unit, a prediction analysis unit, a protection execution unit, a monitoring unit, and a feedback unit. The data collection unit collects data in real time from various sensors and devices installed throughout the city. For example, weather sensors provide data such as temperature, humidity, wind speed, and precipitation, and these are installed on streetlights, traffic lights, and the roofs of public facilities. This makes it possible to capture minute weather changes at various locations in the city. Furthermore, surveillance cameras visually detect road flooding and the scattering of objects by wind. These cameras are installed at major intersections and around public facilities and transmit images in real time. In addition, drones cover a wide area from the air and are useful for grasping the situation in areas that are particularly difficult to access. Drones can fly to the site quickly in the event of a disaster and confirm the damage situation from above. This makes it possible to quickly detect local weather changes and signs of disasters.

The prediction analysis unit transmits the collected data to an AI platform on the cloud and performs analysis. The AI compares past weather data with real-time data and detects abnormal patterns. For example, by using deep learning and a recurrent neural network, it analyzes time-series data and realizes high-accuracy prediction. This makes it possible to predict the possibility of disasters such as floods, strong winds, and thunderstorms in specific areas within the city with high accuracy. The AI can perform more precise predictions by taking into account not only weather data but also topographical data and population density data. A specific example of a prompt sentence to be read into a generative AI is “Predict floods and strong winds that may occur in the city within the next 12 hours based on past data.”

The protection execution unit automatically executes protective measures to protect the infrastructure and residents in the city based on the prediction results. For example, in areas where a flood is predicted, a system is activated in which drainage pumps installed underground are automatically activated to quickly discharge rainwater. This can prevent the flooding of roads and subways. The drainage pumps cooperate with the city's drainage network to efficiently discharge water. In addition, when strong winds are predicted, robots for strengthening the fixation of roadside trees and signboards are activated to perform physical reinforcement work. These robots can grasp the surrounding situation using sensors and perform appropriate reinforcement work.

Furthermore, it is possible to adjust the operation of public transportation and take measures to ensure the safety of passengers. For example, by changing the operation schedules of buses and trains, access to areas requiring evacuation is ensured.

The monitoring unit continuously monitors the situation of the entire city, and if the prediction is incorrect or the situation changes, it quickly adjusts the protective measures. For example, if there is more precipitation than predicted, a backup drainage pump is operated to take additional drainage measures. In addition, by monitoring traffic congestion and the congestion of evacuation routes and adjusting the timing of traffic signals as necessary, it supports smooth evacuation. The monitoring unit collects data in real time and supports quick decision-making.

The feedback unit evaluates the effect of the executed protective measures and collects data for improving the accuracy of the AI model. For example, it analyzes how effective the executed protective measures were, and if the prediction was incorrect, it identifies the cause and provides information for improving the model. This makes it possible to improve the accuracy of subsequent predictions and strengthen the disaster prevention capabilities of the entire city. The feedback unit accumulates data on past disaster responses and can more effectively prepare for future disasters.

In this way, the system enables a quick and efficient response to weather disasters in the entire city by having each unit cooperate to perform weather data collection, analysis, prediction, execution of protective measures at the site, and feedback, and can realize the safety of residents and the protection of infrastructure.

### (Implementation Steps)

### Step 1: Data Collection

In this step, data is collected in real time from various sensors and devices installed throughout the city. Weather sensors provide data such as temperature, humidity, wind speed, and precipitation, and are installed on streetlights, traffic lights, and the roofs of public facilities. This makes it possible to capture minute weather changes at various locations in the city. Furthermore, surveillance cameras visually detect road flooding and the scattering of objects by wind. These cameras are installed at major intersections and around public facilities and transmit images in real time. In addition, drones cover a wide area from the air and are useful for grasping the situation in areas that are particularly difficult to access. Drones can fly to the site quickly in the event of a disaster and confirm the damage situation from above.

### Step 2: Data Analysis and Prediction

The collected data is transmitted to an AI platform on the cloud and analysis is performed. The AI compares past weather data with real-time data and detects abnormal patterns. By using deep learning and a recurrent neural network, time-series data is analyzed to realize high-accuracy prediction. This makes it possible to predict the possibility of disasters such as floods, strong winds, and thunderstorms in specific areas within the city with high accuracy. A specific example of a prompt sentence to be read into a generative AI is “Predict floods and strong winds that may occur in the city within the next 12 hours based on past data.”

### Step 3: Execution of Protective Measures

Based on the prediction results, protective measures are automatically executed to protect the infrastructure and residents in the city. In areas where a flood is predicted, a system is activated in which drainage pumps installed underground are automatically activated to quickly discharge rainwater. This can prevent the flooding of roads and subways. The drainage pumps cooperate with the city's drainage network to efficiently discharge water. In addition, when strong winds are predicted, robots for strengthening the fixation of roadside trees and signboards are activated to perform physical reinforcement work. These robots can grasp the surrounding situation using sensors and perform appropriate reinforcement work. Furthermore, it is possible to adjust the operation of public transportation and take measures to ensure the safety of passengers.

### Step 4: Monitoring and Adjustment

The situation of the entire city is continuously monitored, and if the prediction is incorrect or the situation changes, the protective measures are quickly adjusted. If there is more precipitation than predicted, a backup drainage pump is operated to take additional drainage measures. In addition, by monitoring traffic congestion and the congestion of evacuation routes and adjusting the timing of traffic signals as necessary, smooth evacuation is supported. The monitoring unit collects data in real time and supports quick decision-making.

### Step 5: Feedback and Improvement

The effect of the executed protective measures is evaluated, and data is collected to improve the accuracy of the AI model. It analyzes how effective the executed protective measures were, and if the prediction was incorrect, it identifies the cause and provides information for improving the model. This makes it possible to improve the accuracy of subsequent predictions and strengthen the disaster prevention capabilities of the entire city. The feedback unit accumulates data on past disaster responses and can more effectively prepare for future disasters.

### (Specific Use Case)

For example, consider a case where the system is used to protect infrastructure and residents from weather disasters in a large city. Since this city has a high population density and complex infrastructure, a quick and accurate response is required when a weather disaster occurs.

First, the data collection unit collects data in real time from weather sensors, surveillance cameras, and drones installed throughout the city. The weather sensors provide detailed data such as temperature, humidity, wind speed, and precipitation, and these are installed on streetlights, traffic lights, and the roofs of public facilities. The surveillance cameras are installed at major intersections and around public facilities and visually detect road flooding and the scattering of objects by wind. Drones cover a wide area from the air and are useful for grasping the situation in areas that are particularly difficult to access.

Next, the prediction analysis unit transmits the collected data to an AI platform on the cloud and performs analysis. The AI compares past weather data with real-time data and detects abnormal patterns. By using deep learning and a recurrent neural network, time-series data is analyzed to realize high-accuracy prediction. A specific example of a prompt sentence to be read into a generative AI is “Predict floods and strong winds that may occur in the city within the next 12 hours based on past data.”

Based on the prediction results, the protection execution unit automatically executes protective measures to protect the infrastructure and residents in the city. In areas where a flood is predicted, a system is activated in which drainage pumps installed underground are automatically activated to quickly discharge rainwater. This can prevent the flooding of roads and subways. When strong winds are predicted, robots for strengthening the fixation of roadside trees and signboards are activated to perform physical reinforcement work. These robots can grasp the surrounding situation using sensors and perform appropriate reinforcement work. Furthermore, it is possible to adjust the operation of public transportation and take measures to ensure the safety of passengers.

The monitoring unit continuously monitors the situation of the entire city, and if the prediction is incorrect or the situation changes, it quickly adjusts the protective measures. If there is more precipitation than predicted, a backup drainage pump is operated to take additional drainage measures. In addition, by monitoring traffic congestion and the congestion of evacuation routes and adjusting the timing of traffic signals as necessary, smooth evacuation is supported.

Finally, the feedback unit evaluates the effect of the executed protective measures and collects data for improving the accuracy of the AI model. It analyzes how effective the executed protective measures were, and if the prediction was incorrect, it identifies the cause and provides information for improving the model. This makes it possible to improve the accuracy of subsequent predictions and strengthen the disaster prevention capabilities of the entire city.

In this way, the system enables a quick and efficient response to weather disasters in the entire city, and can realize the safety of residents and the protection of infrastructure.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

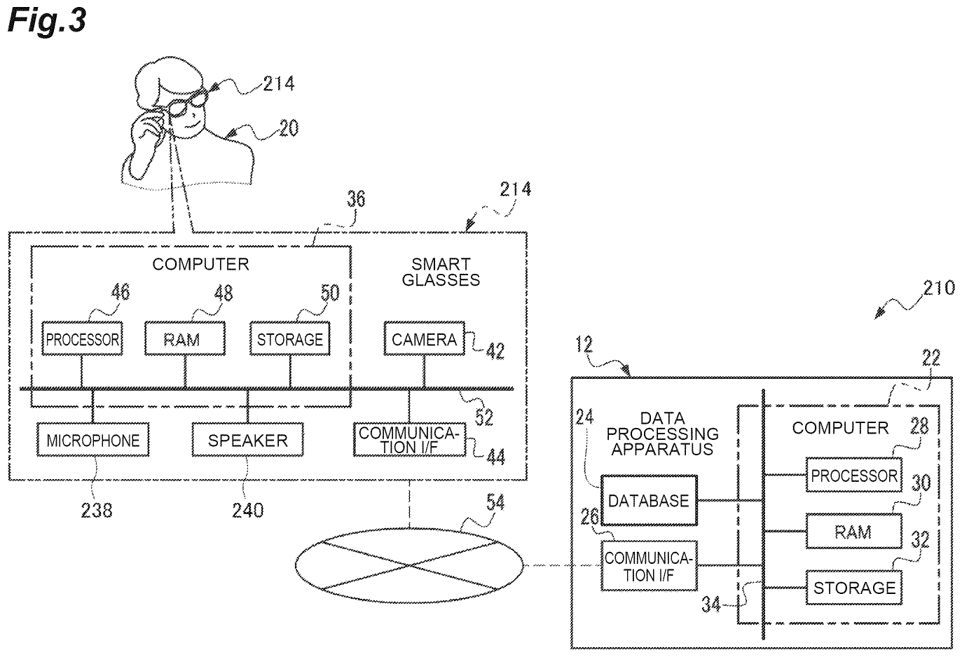

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

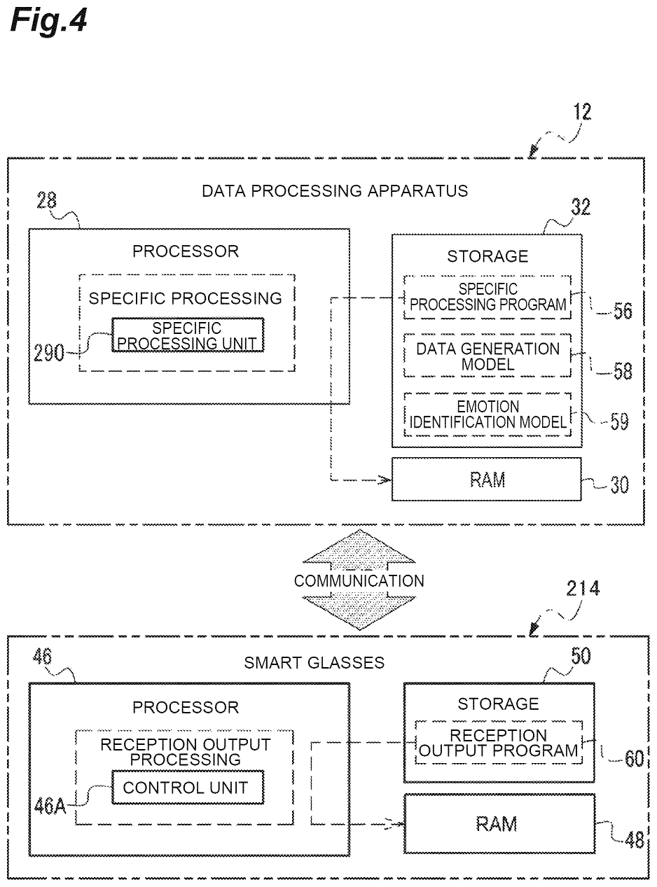

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

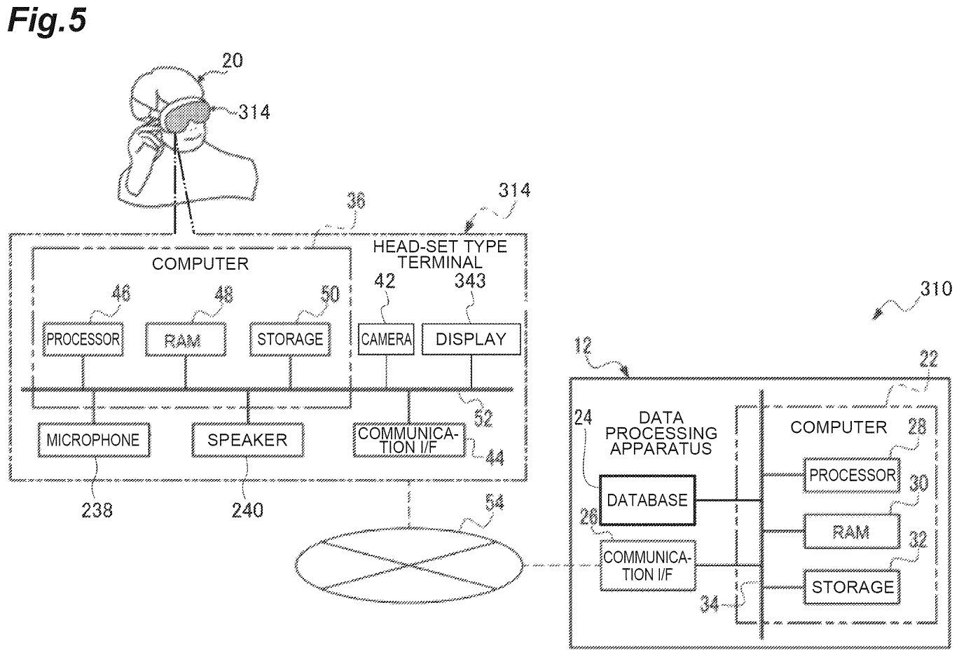

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

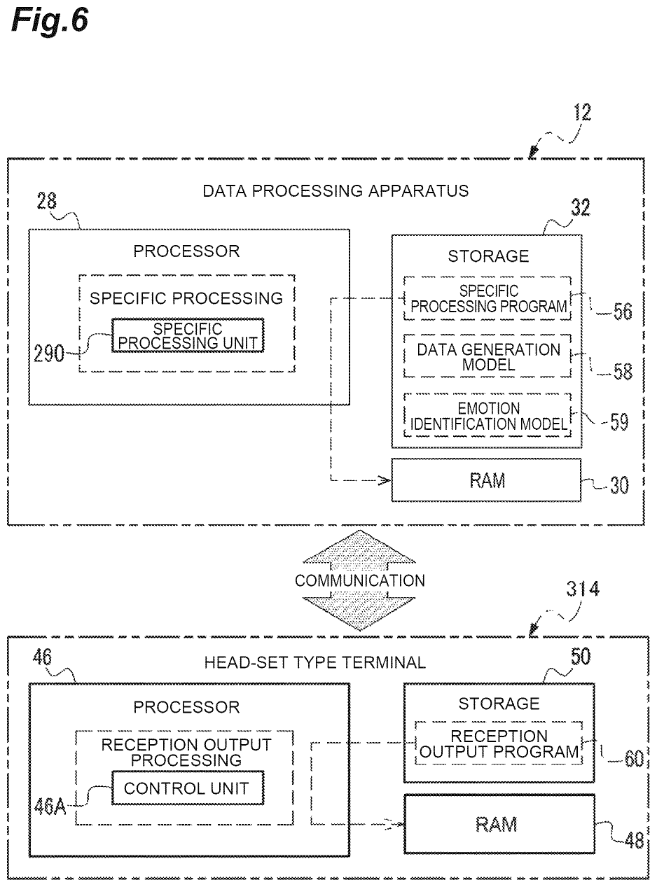

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

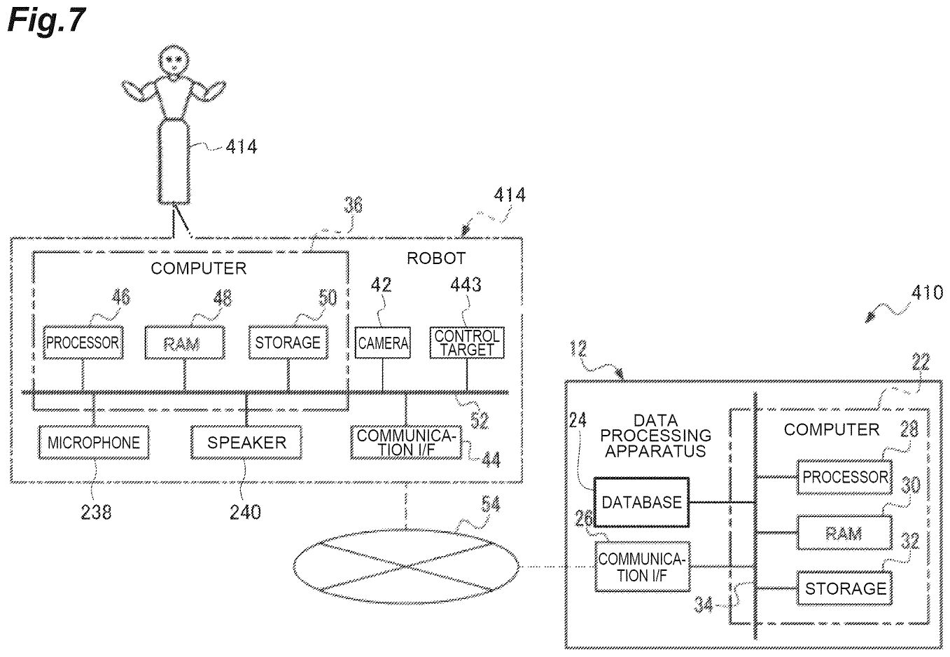

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

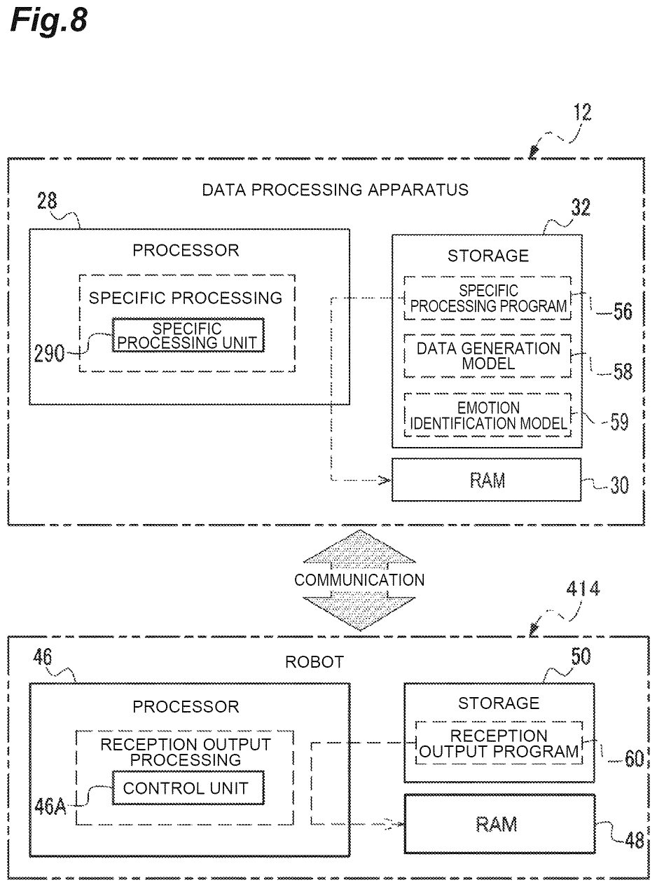

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

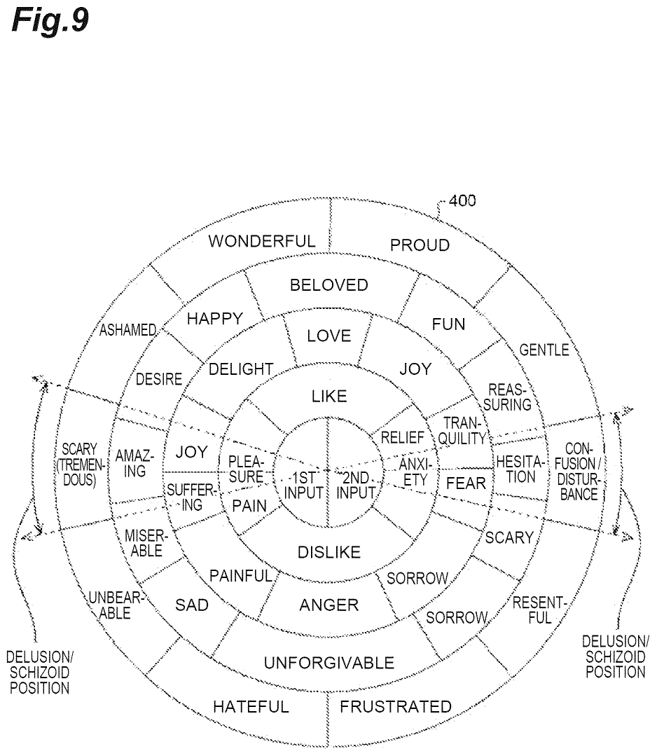

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

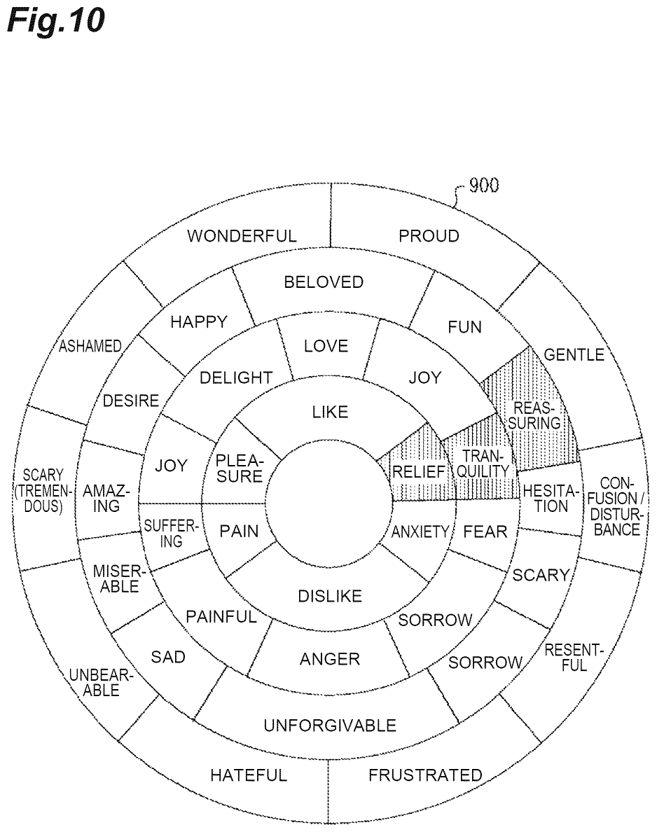

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a data collection unit, a prediction analysis unit, and a protection execution unit. The data collection unit has a function of collecting weather data in real time from weather sensors, surveillance cameras, drones, and the like installed throughout a city, thereby making it possible to quickly detect local weather changes and signs of disasters. The prediction analysis unit has a function of analyzing the collected data using a machine learning algorithm to predict the possibility of disaster occurrence in a specific area within the city with high accuracy. The protection execution unit has a function of automatically executing protective measures to protect the infrastructure and residents in the city based on the prediction results, and can respond quickly to disasters such as floods and strong winds.

In some examples, the data collection unit integrates data from weather satellites, ground-based weather observation stations, and weather radars, and acquires detailed data such as wide-area cloud movement and precipitation patterns, local temperature, humidity, wind speed, wind direction, and atmospheric pressure. This is particularly useful for detecting sudden weather changes such as guerrilla heavy rains, and makes it possible to grasp the weather situation of the entire city in detail.

### (Claim 3)

In some examples, the protection execution unit has a function of automatically activating a drainage pump in an area where a flood is predicted to prevent flooding of roads and subways, and activates a robot for strengthening the fixation of roadside trees and signboards when strong winds are predicted. Furthermore, it can adjust the operation of public transportation and take measures to ensure the safety of passengers.

An example system for predicting weather changes may include circuitry. The circuitry may be configured to: predict a weather change by analyzing collected weather data; and automatically execute a protective measure based on the predicted weather change.

In some examples, predicting the weather change may include predicting a climate change using a machine learning algorithm by collecting data from a weather satellite, a ground-based weather observation station, and a weather radar in real time. In some examples, executing the protective measure may include executing the protective measure for protecting a crop by controlling a robot to automatically stack sandbags based on the prediction result.

In some examples, executing the protective measure may include: determining whether there is a high possibility of a disaster occurring based on an evaluation of the prediction result; and when it is determined that there is a high possibility of a disaster occurring, controlling a robot to place a sandbag at an accurate position using a GPS and a sensor, and controlling a drainage pump to discharge excess water.

An example method of predicting weather changes may include predicting a weather change by analyzing collected weather data; and automatically executing a protective measure based on the predicted weather change.

What is claimed is:

1. A system for predicting weather changes, the system comprising circuitry,
wherein the circuitry is configured to:
predict a weather change by analyzing collected weather data; and
automatically execute a protective measure based on the predicted weather change.

2. The system according to claim 1,
wherein predicting the weather change includes predicting a climate change using a machine learning algorithm by collecting data from a weather satellite, a ground-based weather observation station, and a weather radar in real time, and
wherein executing the protective measure includes executing the protective measure for protecting a crop by controlling a robot to automatically stack sandbags based on the prediction result.

3. The system according to claim 1, wherein executing the protective measure includes:
determining whether there is a high possibility of a disaster occurring based on an evaluation of the prediction result; and
when it is determined that there is a high possibility of a disaster occurring, controlling a robot to place a sandbag at an accurate position using a GPS and a sensor, and controlling a drainage pump to discharge excess water.

4. A method of predicting weather changes, the method comprising:
predicting a weather change by analyzing collected weather data; and
automatically executing a protective measure based on the predicted weather change.
